(19) United States
(12) Patent Application Publication
(10) Pub. No.: US 2023/0289676 A1
(43) Pub. Date: Sep. 14, 2023

(54) SYSTEMS AND METHODS FOR AUTOMATIC DATA OBJECT TRACKING AND DATA OBJECT RELATED COMMUNICATION GENERATION

(71) Applicant: Sucess Mortgage Partners, Inc., Plymouth, MI (US)

(72) Inventor: Owen V. Lee, Northville, MI (US)

(21) Appl. No.: 18/120,087

(22) Filed: Mar. 10, 2023

Related U.S. Application Data
(60) Provisional application No. 63/319,099, filed on Mar. 11, 2022.

(51) Int. Cl. G06Q 10/0631

(52) U.S. Cl. CPC G06Q 10/063114

(57) ABSTRACT

A method includes receiving at least one data object associated with recent activity of a client, updating a data store with the at least one data object associated with the recent activity of the client, and querying the data store for at least one data object associated with previous activity of the client. The method also includes determining that the client meets minimum standards for a service provided by an entity, determining an availability of an agent, and determining which client information is pertinent to providing the service to the client. The method also includes identifying a computing device associated with the agent associated with the entity, generating at least one messaging data object including one or more text strings indicating the client information, and providing the messaging data object to the computing device of the agent associated with the entity.

### CROSS-REFERENCES TO RELATED APPLICATIONS

This patent application claims priority to U.S. Provisional Patent Application Ser. No. 63/319,099, filed Mar. 11, 2022 which is incorporated herein by reference in its entirety.

### TECHNICAL FIELD

The present disclosure relates to data objects and in particular to systems and methods for data object tracking and data object-related communication generation.

### BACKGROUND

Mortgage and loan entities typically generate mortgages and/or other loans for individuals seeking to secure such mortgages and/or other loans. Generation of such mortgages and/or other loads may include the generation and/or storage of various data objects corresponding to data associated with the mortgage and loan entity, the various mortgage and/or other loans, the individuals securing such mortgages, and/or other loans, collateral associated with such mortgages and/or other loans, and the like.

### SUMMARY

An aspect of the disclosed embodiments may a centralized process for the acquisition of potential business opportunities with existing clients of an entity. For example, embodiments described herein include an application programming interface (API) that is configured to receive data associated with recent activity of a client and a business acquisition unit that is configured to update a data store with the data associated with the recent activity of the client, query the data store for data associated with previous activity of the client, and determine, based on the data associated with the recent activity of the client and the data associated with the previous activity of the client, that the client meets minimum standards for a service provided by an entity. The business acquisition unit is also configured to determine an availability of an agent associated with the entity to provide the service to the client, determine which client information is pertinent to providing the service to the client, and identify a computing device associated with the agent associated with the entity. Additionally, embodiments described herein include a message generation API that is configured to generate a messaging data object including indicating the client information and provide the messaging data object to the computing device of the agent associated with the entity.

Another aspect of the disclosed embodiments includes a system, comprising one or more processors, and one or more memory devices. The one or more memory devices store programming logic that, when executed by the one or more processors, cause the one or more processors to: receive, at an application programming interface (API), at least one data object associated with recent activity of a client; update a data store with the at least one data object associated with the recent activity of the client; query the data store for at least one data object associated with previous activity of the client; determine, based on the at least one data object associated with the recent activity of the client and the at least one data object associated with the previous activity of the client, that the client meets minimum standards for a service provided by an entity; determine an availability of an agent associated with the entity of the entity to provide the service to the client; determine which client information is pertinent to providing the service to the client, the client information being associated with the at least one data object associated with the recent activity of the client and the at least one data object associated with the previous activity of the client; identify a computing device associated with the agent associated with the entity; generate, at a message generation API, at least one messaging data object including one or more text strings indicating the client information; and provide the messaging data object to the computing device of the agent associated with the entity.

Another aspect of the disclosed embodiments includes a system, comprising one or more processors, and one or more memory devices. The one or more memory devices store programming logic that, when executed by the one or more processors, cause the one or more processors to: update a data store with the at least one data object associated with the recent activity of the client; query the data store for at least one data object associated with previous activity of the client; determine, based on the at least one data object associated with the recent activity of the client and the at least one data object associated with the previous activity of the client, that the client meets minimum standards for a service provided by an entity; determine an availability of an agent associated with the entity of the entity to provide the service to the client; determine which client information is pertinent to providing the service to the client, the client information being associated with the at least one data object associated with the recent activity of the client and the at least one data object associated with the previous activity of the client; and identify a computing device associated with the agent associated with the entity.

Another aspect of the disclosed embodiments includes a method that includes receiving at least one data object associated with recent activity of a client; updating a data store with the at least one data object associated with the recent activity of the client; querying the data store for at least one data object associated with previous activity of the client; determining, based on the at least one data object associated with the recent activity of the client and the at least one data object associated with the previous activity of the client, that the client meets minimum standards for a service provided by an entity; determining an availability of an agent associated with the entity to provide the service to the client; determining which client information is pertinent to providing the service to the client, the client information being associated with the at least one data object associated with the recent activity of the client and the at least one data object associated with the previous activity of the client; identifying a computing device associated with the agent associated with the entity; generating at least one messaging data object including one or more text strings indicating the client information; and providing the messaging data object to the computing device of the agent associated with the entity.

### BRIEF DESCRIPTION OF THE DRAWINGS

FIG. 1 generally illustrates a system for training a neural network, according to the principles of the present disclosure.

FIG. 2 generally illustrates a computer-implemented method for training and utilizing a neural network, according to the principles of the present disclosure.

FIG. 3 is a flow diagram that generally illustrates a high-level overview of the computer-implemented method for generating a notification for a loan officer, according to the principles of the present disclosure.

FIG. 4 is a flow diagram generally illustrating a high-level overview of the checks associated with generating a notification for a loan officer, according to the principles of the present disclosure.

FIG. 5 is a flow diagram generally illustrating a high-level overview of the computer-implemented method for managing and tracking sales lead notifications to a loan officer, according to the principles of the present disclosure.

FIG. 6 is a block diagram generally illustrating the computing environment wherein the computer-implemented method described herein operates, according to the principles of the present disclosure.

FIG. 7 is a flow diagram generally illustrating a high-level overview of the computer-implemented method for a centralized process for the acquisition of potential business opportunities with existing clients of an entity, according to the principles of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art may understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure provide a centralized process for the acquisition of potential business opportunities with existing clients of an entity. For example, embodiments described herein include an application programming interface (API) that is configured to receive data associated with recent activity of a client and a business acquisition unit that is configured to update a data store with the data associated with the recent activity of the client, query the data store for data associated with previous activity of the client, and determine, based on the data associated with the recent activity of the client and the data associated with the previous activity of the client, that the client meets minimum standards for a service provided by an entity. The business acquisition unit is also configured to determine an availability of an agent associated with the entity to provide the service to the client, determine which client information is pertinent to providing the service to the client, and identify a computing device associated with the agent associated with the entity. Additionally, embodiments described herein include a message generation API that is configured to generate a messaging data object indicating the client information and provide the messaging data object to the computing device of the agent associated with the entity.

By centralizing this process, computer functionality is improved by helping to reduce computing cycles and unnecessary data processing across an entity's network of computing devices. Additionally, this process ensures that all agents associated with the entity have access to the most current information associated with a client and reduces duplicate data.

Embodiments of the present disclosure are described in detail with reference to the mortgage and lending industry but can be employed in various industries and sectors. Embodiments of the present disclosure can be employed in commerce, construction, education, health services, tourism, transport, and other sectors of the financial industry (e.g., banks, insurance companies, etc.).

“Entity,” as referenced herein, refers to a legal entity representing an association of people, such as voluntary associations, business entities, financial entities, educational institutions, enterprises, etc. “Client,” as referenced herein, refers to a person or organization using one or more services of an entity. “Service,” as referenced herein, refers to any act or use, provided by an entity, in which a client pays to receive. “Agent associated with the entity,” as referenced herein, refers to a human individual or group of individuals including employees, contractors, and the like and/or a virtual agent, such as a bot, AI, and the like who act on behalf of the entity.

For example, within the context of the mortgage and lending industry, mortgage and loan entities typically generate mortgages and/or other loans for clients (e.g., borrowers) seeking to secure such mortgages and/or other loans. Generation of such mortgages and/or other loads may include the generation and/or storage of various data objects corresponding to data associated with the mortgage and loan entity, the various mortgage and/or other loans, the individuals securing such mortgages and/or other loans, collateral associated with such mortgages and/or other loans, and the like.

Mortgage and/or loan entities often store such data in relatively large databases, which may be useful for providing information regarding various individuals securing such mortgages and/or other loans (e.g., which may be referred to herein as borrows, mortgagees, and the like). Such information may be combined with previous borrower tracking to predict when a previous borrower is a potential borrower looking for a new loan or to refinance an existing loan.

A system that tracks potential borrowers' activity and generates sales leads for loan officers may lead to greater sales. However, typical entities lack tracking of loan officer usage of a sales lead as well as tracking the ultimate success of that lead. Further, such entities may lack functionality for automatically reminding loan officers of a potential borrower.

Accordingly, the systems and methods described herein may be configured to provide the generation of a lead based on potential borrower information. The systems and methods described herein may be configured to further refine the generation of the lead by tracking the ultimate success of the sales lead. The systems and methods described herein may be configured to provide metrics associated with the greatest likelihood of success, which may be used (e.g., and more heavily weighted) in future determinations of sales leads.

The systems and methods described herein may be configured to solve the problem of loan officers not taking action on sales lead alerts by sending a message to a computing device of the loan officer with a clickable link to call the sales lead, which may to drastically increase the simplicity of actions taken by the loan office to contact the sales lead.

The systems and methods described herein may be configured to solve this issue with a click to call link with customer information so they may have an informed conversation without having to log into a separate system. The system and methods described herein may be configured to generate automatic reminders (e.g., within business hours or other suitable timeframe), to track if they have used the click to call the customer storing that data, and stopping the text reminders to call upon determining the link has been activated.

The systems and methods described herein may be configured to create a sales lead data object, the data object contains all relevant information regarding the alert on the lead. The systems and methods described herein may be configured to send the data object to a public API endpoint (e.g., such as in JSON format).

The systems and methods described herein may be configured to receive a data object by the public API endpoint (e.g., the data may be deserialized from JSON and validated against a set of data integrity rules).

The systems and methods described herein may be configured to check data points from the data object to ensure it meets minimal data requirements. If the validation passes, the systems and methods described herein may be configured to send the data object to an internal server.

The systems and methods described herein may be configured to receive the data object from the public API endpoint. The systems and methods described herein may be configured to store the data object in an internal database (e.g., such as in a structured query language database, other suitable database or data structure, or a combination thereof).

The systems and methods described herein may be configured to use an object-relational mapping framework to open a connection to the internal database. The systems and methods described herein may be configured to query the internal database for existing records that match.

The systems and methods described herein may be configured to store the data object in the internal database if a record does not already exist.

The systems and methods described herein may be configured to pull the following data from the internal database based on data points in the data object. Those data points may include the loan officer data, the potential borrower's previous loan data, etc.

The systems and methods described herein may be configured to receive at least one data object associated with recent activity of a client and update a data store with the at least one data object associated with the recent activity of the client. For example, the borrower's recent activity data may include any of the following: loan type, time since the last loan, amount of money that can be saved compared to current loan, FICO score, bankruptcies, foreclosures, late payments or any other available data on the potential borrower.

The systems and methods described herein may be configured to query the data store for at least one data object associated with previous activity of the client. For example, the previous activity of the client may include any of the following: information associated with a previous or current loan, loan type, time since the last loan, amount of money that can be saved compared to current loan, FICO score, bankruptcies, foreclosures, late payments or any other available data on the potential borrower.

The systems and methods described herein may be configured to determine, based on the at least one data object associated with the recent activity of the client and the at least one data object associated with the previous activity of the client, that the client meets minimum standards for a service provided by an entity. To help illustrate, in one scenario, based on loan information associated with a previous loan and the client's current FICO score, it may be determined if the client meets minimum standards or requirements (e.g., debt-to-income ratio, FICO score, work history, etc.) to qualify for a loan or mortgage.

The systems and methods described herein may be configured to check the loan officer data, potential borrowers' loan data, and borrower's recent activity for the loan officer, potential borrower's previous loan, and potential borrower's recent activity.

For the loan officer data, the systems and methods described herein may be configured to determine an availability (e.g., available to receive the text, available to enage the client, etc.,) of an agent associated with the entity to provide the service to the client. For example, the systems and methods described herein may check if the loan officer is still an active agent associated with the entity with the organization. As another example, the systems and methods described herein may check if the loan officer has opted out of notifications. Still yet, the systems and methods described herein may check if the loan officer has a cell or mobile number registered.

For the potential borrower's previous loans, the systems and methods described herein may be configured to check if the potential borrower has opted out of future communications. The systems and methods described herein may be configured to check if the borrower has a phone number registered.

For the potential borrower's recent activity data, the systems and methods described herein may be configured to check if the potential borrower has submitted a new loan application, and to whom. The systems and methods described herein may be configured to check if the loan officer has already called the borrower regarding this alert.

If all the checks pass, the systems and methods described herein may be configured to send the loan officer data and borrowers' loan data to the messaging service (such as Twilio) to communicate the data to the loan officer.

The systems and methods described herein may be configured to identify a computing device associated with the agent associated with the entity, generate at least one messaging data object including one or more text strings indicating the client information, and provide the messaging data object to the computing device of the agent associated with the entity. For example, the systems and methods described herein may be configured to send to the messaging service the loan officer data and borrowers' loan data to take further actions. The systems and methods described herein may be configured to instruct the messaging service to create two hypertext transfer protocol (http) post requests. The requests may include a short message service (SMS) message body or other suitable message body using the loan officer's name, borrower's name, and loan details. The request may further include the loan officer's phone number to send the SMS message to. The request may further include the organization phone number that the SMS message may come from.

The systems and methods described herein may be configured to authenticate with its public API's. The systems and methods described herein may be configured to send the first http post request to the messaging service's SendSMS public API endpoint with a delivery time of ASAP, it may then send the second http post request to the same API endpoint with a delayed delivery time of one hour or any appropriate period of time.

The systems and methods described herein may be configured to receive, from a sales lead server, a data object having loan data related to a potential borrower. The systems and methods described herein may be configured to compare the potential borrower data stored in the data object with the corresponding potential borrower data in an internal server associated with the potential borrower.

The systems and methods described herein may be configured to determine which client information (e.g., borrower's contact information, borrowing limit, employment history, etc.) is pertinent to providing the service (e.g., a mortgage) to the client, the client information being associated with the at least one data object associated with the recent activity of the client and the at least one data object associated with the previous activity of the client. For example, the systems and methods described herein may be configured to generate a potential borrower data interface where the potential borrower data interface includes potential borrower data most associated with leading to a new loan based on loan history data from the internal server. The systems and methods described herein may be configured to determine, based on potential borrower data in the internal server, a loan officer associated with the potential borrower. The systems and methods described herein may be configured to generate message to the loan officer having a first link associated with the potential borrower data interface and a second link associated with a contact information of the potential borrower from the internal server. The systems and methods described herein may be configured to generate a notification to the loan officer based on tracking the first link and determining it has not been used. The systems and methods described herein may be configured to determine a level of success in creating a new loan for the potential borrower and storing the loan data with the data from the potential borrower data interface in the internal server.

The systems and methods described herein may be configured to receive at least one data object associated with a potential borrower. The systems and methods described herein may be configured to determine, based on the at least one data object, whether to contact the potential borrower. The systems and methods described herein may be configured to, in response to a determination to contact the potential borrower, generate, using at least the at least one data object, one or more text strings indicating information associated with the potential borrower. The systems and methods described herein may be configured to generate, using a message generation application programming interface, at least one messaging data object including the one or more text strings indicating the information associated with the potential borrower. The systems and methods described herein may be configured to identify a computing device associated with an intended recipient of the messaging data object, the recipient being associated with the potential borrower. The systems and methods described herein may be configured to selectively communicate the messaging data object to the computing device associated with the recipient. The systems and methods described herein may be configured to, after a predetermined period and in response to information indicating that the recipient has not contacted the potential borrower, subsequently communicate, at least, the messaging data object to the computing device of the recipient.

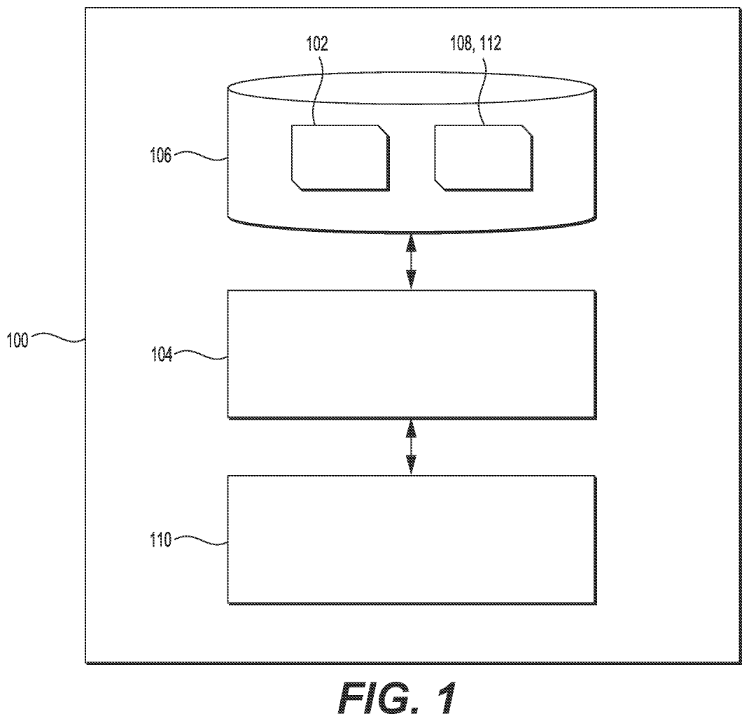

FIG. 1 shows a system 100 for training a neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It may be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input-output of a previous layer, or for a first layer of the stack of layers, an initial activation, and a part of the input of the stack of layers.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

For example, within the context of the mortgage and lending industry, training data 102 for a neural network may include historical client information associated with clients who previously did and did not qualify for a mortgage or loan. Client information may include clients contact information, desired loan amount, purpose for the loan, gross monthly income, mortgage payment, employer information, insurance information, property tax information, FICO score, monthly expenses, etc. To help illustrate, a model generator may provide training data 102 to a machine learning algorithm. The model generator may also include a machine learning application that implements the machine learning algorithm to generate the trained model data 112. When the machine learning algorithm is implemented, it may find patterns in the historical client information and output a model that captures these patterns to help determine which client information is pertinent to providing the service (e.g., a mortgage for a client) to the client. For example, the model generator may implement an artificial neural network learning algorithm to generate the trained model data 112 as a neural network that is an interconnected group of artificial neurons. The neural network may be presented with the client information including at least data associated with the recent activity of the client and data associated with the previous activity of the client to identify information associated with the client that is pertinent to providing the new service to the client.

Additionally, system 100 may be used to predict the likelihood that the client will be successful in qualifying for the service. A neural network may be trained on the historical client information and based on information associated with a client (e.g., recent activity of the client), using the neural network, a prediction can be made if the client will successfully qualify for the service, such as a loan or mortgage. Trained model data 112 may output a neural network prediction score based on information associated with the client.

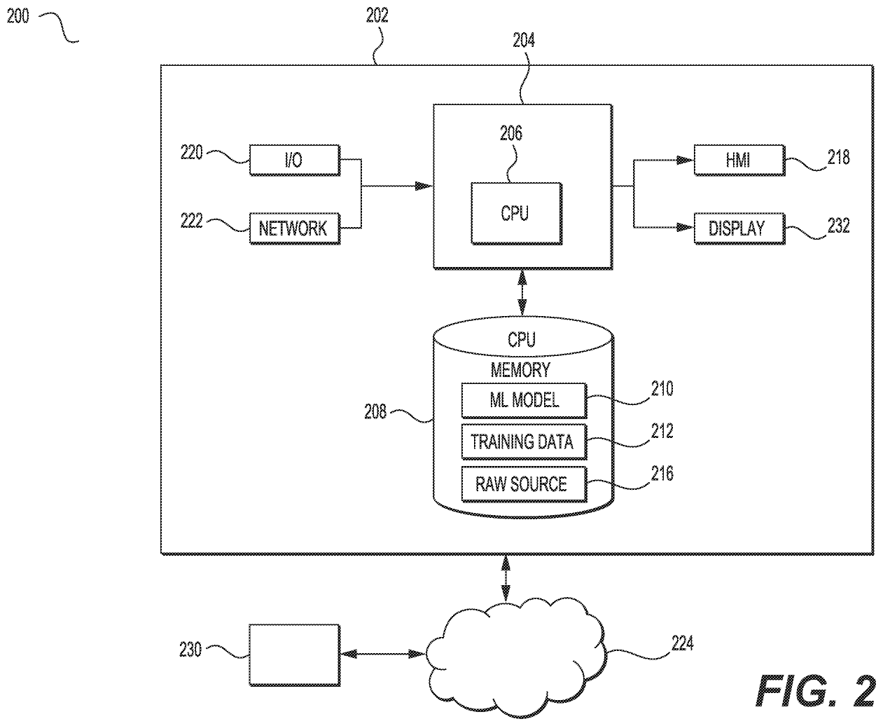

FIG. 2 a computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors. In some embodiments, the system 200 may be configured to perform the systems and methods described herein, using the system 100 and/or various classical computing algorithms.

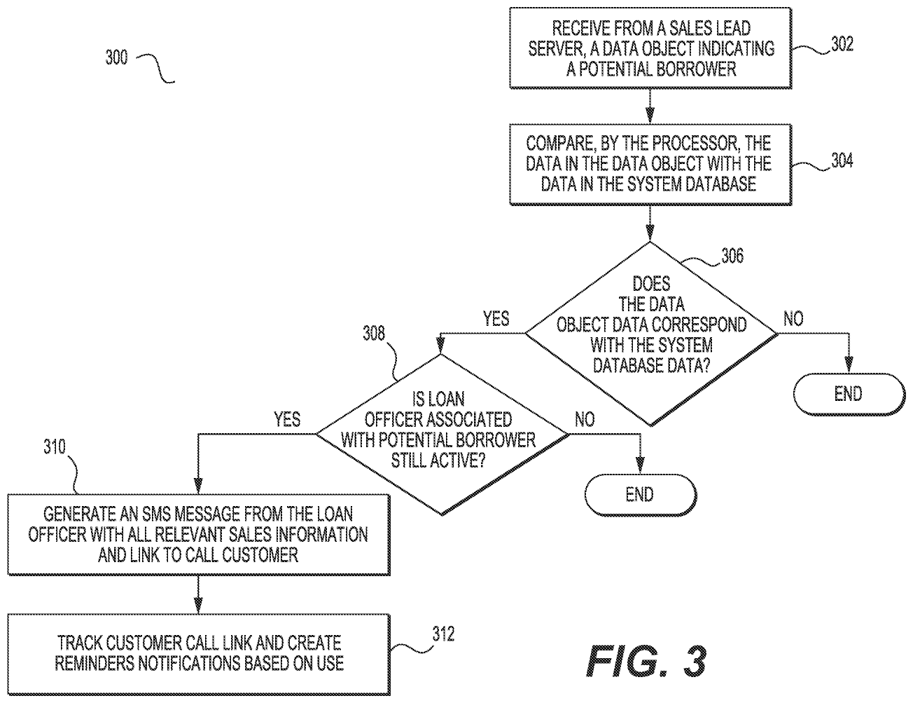

FIG. 3 is a flow diagram that generally illustrates a high-level overview of the computer-implemented method for generating a notification for a loan officer, according to the principles of the present disclosure. At 302, the business acquisition unit 300 receives from a sales lead server, a data object generated based on a determination that a borrower on record is interested in a new loan or refinancing of an old loan. Such a determination can be made based on a tracking of internally available potential borrower data (i.e., loan history data, time since last loan, rate of previous loan in comparison current rates, and the like) and publicly available borrower data (i.e., FICO score, bankruptcies, foreclosures, late payments, and the like).

At 304, the business acquisition unit 300 compares the data received in the data object with the corresponding data for the same potential borrower available on the internal server. The data integrity rules check data points from the data object to ensure it meets minimal data requirements. If the validation passes, the public API endpoint may send the data object to an internal data processing service. The systems and methods described herein may check the loan officer data, potential borrowers' loan data, and borrower's recent activity for the loan officer, potential borrower's previous loan, and potential borrower's recent activity.

At 306, the business acquisition unit 300 determines if the data from the data object has been sufficiently verified at 304. If the business acquisition unit 300 determines that the data is appropriately validated then the business acquisition unit 300 continues to 308. Otherwise, the system determines that there is not a valid sales lead and ends. At 308 the business acquisition unit 300 searches for a loan officer associated with the potential borrower, based on data in the internal database. If there is no associated loan officer or the associated loan officer is no longer active in the organization, then the process ends. Otherwise, if the business acquisition unit 300 finds an active loan officer associated with the potential borrower the business acquisition unit 300 continues to 310.

At 310 the business acquisition unit 300 generates a message for the loan officer. The message sent to the loan officer can be by any communication means such as, but not limited to, SMS text message, email, instant message, and the like. The message contains at least two links, one link to initiate communication with the potential borrower based on contact information from the data object or the internal server. The link is trackable, when the loan officer activates it, the business acquisition unit 300 will be notified of the activation.

At 312, the loan officer will continue to receive reminders to communicate with the potential borrower until the business acquisition unit 300 detects an activation. The second link in the communication is a link to an interface generated by the business acquisition unit 300 including the data related to the potential borrower. The information in the interface is determined to be most relevant to a successful interaction with the potential borrower based on past data and trends of similar loans from the internal database or the sales lead database. After an interaction between the loan officer and potential borrower concludes, the business acquisition unit 300 will store all records relating to the interaction including the outcome (i.e., no new service provided, new loan provided, current loan refinancing provided).

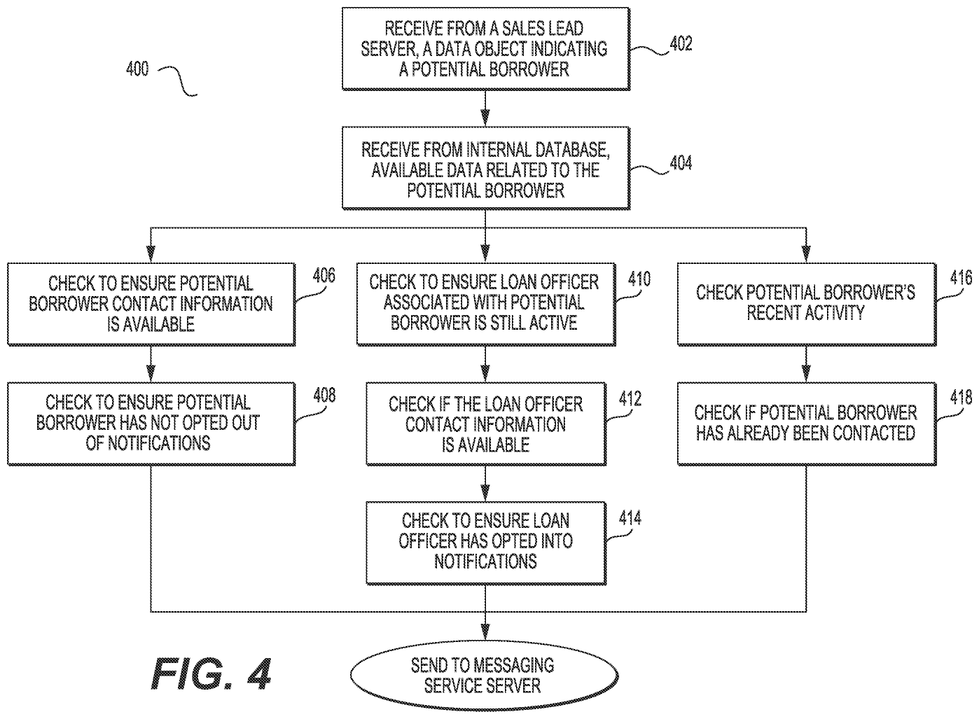

FIG. 4 is a flow diagram generally illustrating a high-level overview of the checks associated with generating a notification for a loan officer, according to the principles of the present disclosure. At 402, the system 400 (another exemplary embodiment of business acquisition unit 300 of FIG. 3) receives from a sales lead server, a data object generated based on a determination that a borrower on record is interested in a new loan or refinancing of an old loan. Such a determination can be made based on a tracking of internally available potential borrower data (i.e., loan history data, time since last loan, rate of previous loan in comparison current rates, and the like) and publicly available borrower data (i.e., FICO score, bankruptcies, foreclosures, late payments, and the like).

At 404, the system 400 compares the data received in the data object with the corresponding data for the same potential borrower available on the internal server. The data integrity rules check data points from the data object to ensure it meets minimal data requirements. If the validation passes, the public API endpoint may send the data object to an internal data processing service. The systems and methods described herein may check the loan officer data, potential borrowers' loan data, and borrower's recent activity for the loan officer, potential borrower's previous loan, and potential borrower's recent activity.

At 406-418, the system 400 may check the loan officer data, potential borrowers' loan data, and borrower's recent activity for the loan officer, potential borrower's previous loan, and potential borrower's recent activity.

At 406, the system 400 checks if the potential borrower has opted out of future communications and, at 408, checks if the borrower has a phone number registered. If the user does not have contact information on record or has opted out of the communication then the system ends operations for the borrower.

At 410, the system 400 checks the loan officer data, specifically, the system 400 may check if the loan officer is still an active agent associated with the entity with the organization. At 414, the system 400 may check if the loan officer has opted out of notifications. At 412, the system 400 may check if the loan officer has a cell or mobile number registered. If any of the checks are not passed, then the system discontinues operations for the potential borrower.

At 416, the system 400 checks the potential borrower's recent activity data. Specifically, at 416, the system 400 may check if the potential borrower has submitted a new loan application, and to whom. At 418, the system 400 may check if the loan officer has already called the borrower regarding this alert. After all checks are completed, the system 400 sends the communication to the messaging server.

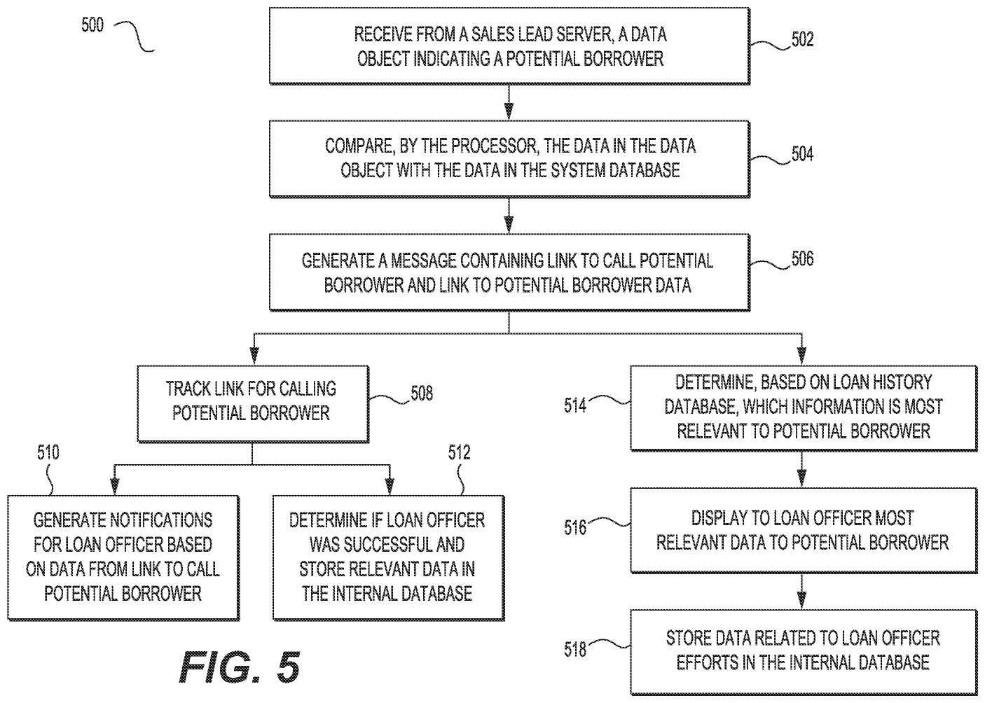

FIG. 5 is a flow diagram generally illustrating a computer-implemented method for managing and tracking sales lead notifications to a loan officer, according to the principles of the present disclosure. At 502, the system 500 (another exemplary embodiment of business acquisition unit 300 of FIG. 3) receives from a sales lead server, a data object generated based on a determination that a borrower on record is interested in a new loan or refinancing of an old loan. Such a determination can be made based on a tracking of internally available borrower data (i.e., loan history data, time since last loan, rate of previous loan in comparison current rates, and the like) and publicly available borrower data (i.e., FICO score, bankruptcies, foreclosures, late payments, and the like).

At 504, the system 500 compares the data received in the data object with the corresponding data for the same potential borrower available on the internal server. The data integrity rules check data points from the data object to ensure it meets minimal data requirements. If the validation passes, the public API endpoint may send the data object to an internal data processing service. The systems and methods described herein may check the loan officer data, potential borrowers' loan data, and borrower's recent activity for the loan officer, potential borrower's previous loan, and potential borrower's recent activity.

At 506 the system 500 generates a message for the loan officer. The message sent to the loan officer can be by any communication means such as, but not limited to, SMS text message, email, instant message, and the like. The message contains at least two links, one link to initiate communication with the potential borrower based on contact information from the data object or the internal server. At 508, the system 500 tracks the communication link, when the loan officer activates it, the system 500 will be notified of the activation. At 510, the loan officer will receive reminders to communicate with the potential borrower until the system 500 detects an activation. At 512, the system 500 determines that the interaction was successful and stores data related to the interaction in the internal server database.

The second link in the communication is a link to an interface generated by the system 500 including the data related to the potential borrower. At 514, the system 500 determines which information for the interface is most relevant to a successful interaction with the potential borrower based on past data and trends of similar loans from the internal database or the sales lead database. At 516, the system displays to the loan officer the interface, where the ordering and arrangement of the data is based on what is most relevant to the potential borrower and/or what is most likely to lead to a successful interaction. A successful interaction may be any additional services provided to the potential borrower, and an unsuccessful interaction may be no additional services provided.

At 518, after an interaction between the loan officer and potential borrower concludes, the system 500 will store all records relating to the interaction including the outcome (i.e., no new service provided, new loan provided, current loan refinancing provided).

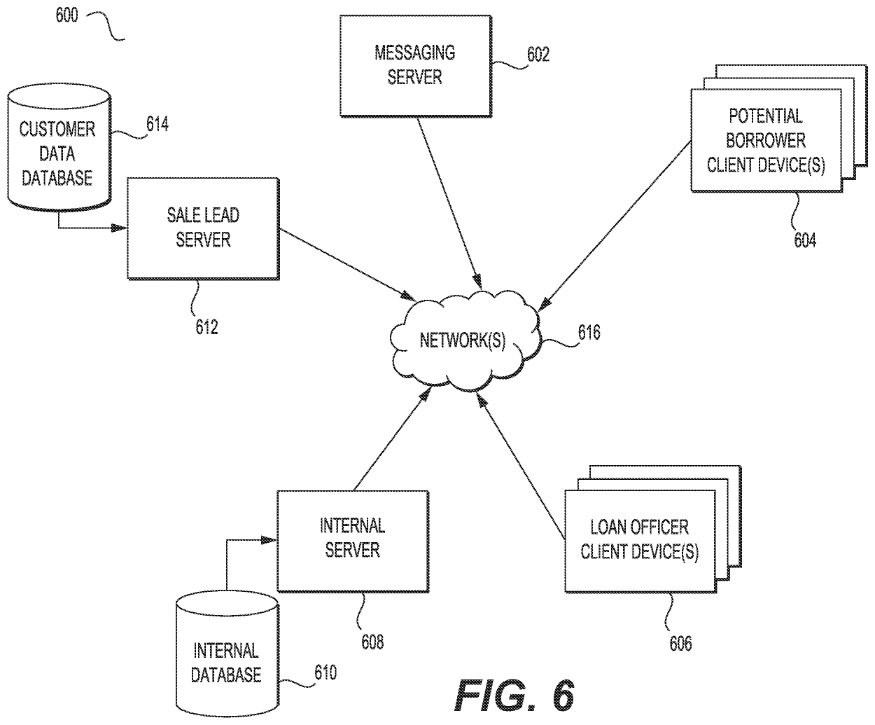

FIG. 6 is a block diagram generally illustrating the computing environment wherein the computer-implemented method described herein operates, according to the principles of the present disclosure. The computing environment 600 includes a messaging server 602 the managing communications to the loan officer. The communications include the sales lead communication as well as notifications to act upon the sales lead communication. Communications may be SMS text messages, emails, instant messages, and the like. The computing environment 600 further includes potential borrower client devices 604. The potential borrower client devices receive communications from the messaging server 602 that are initiated by a loan officer. A potential borrower client device may be a smart phone, a land-line telephone, a personal computing device, and the like.

The computing environment 600 may further include a loan officer client devices 606. The loan officer client device 606 may receive communications from the messaging server 602 and initiate communications with the potential borrower client device 604. A loan officer client device may be a smart phone, a land-line telephone, a personal computing device, and the like.

The computing environment 600 may further include an internal server 608 having an internal database 610. The internal server 608 may perform various functions of the systems and methods described herein. The internal server 608 has a hardware memory and a processor to execute processes such as storing historical loan data in the internal database 610. The internal database 610 storing all internally available potential borrower data.

The computing environment further includes a sales lead server 612 with a customer data database 614. The sales lead server 612 tracks previous borrower information and determines when one becomes a potential borrower. A sales lead data object is created by the sales lead server 612, the data object contains all relevant information regarding the alert on the lead. The sales lead system sends the data object to a public API endpoint (e.g., such as in JSON format). The potential borrower data upon which the sales lead server makes its determination is stored in customer database 614.

All the devices in the computing environment 600 being communicatively coupled to each other via network 616. Network 616 may be a global system of interconnected computer networks that uses the Internet protocol suite (TCP/IP) to communicate between networks and devices. The network 616 may alternatively be an intranet network which is a computer network for sharing information, easier communication, collaboration tools, operational systems, and other computing services within an organization, usually to the exclusion of access by outsiders.

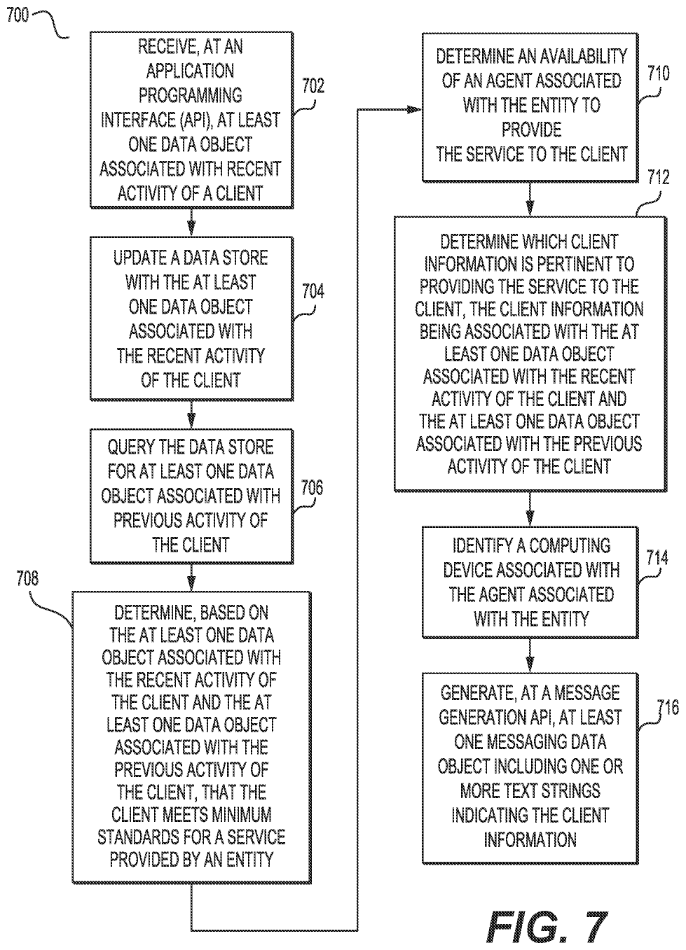

FIG. 7 is a flow diagram generally illustrating a computer-implemented method for a centralized process for the acquisition of potential business opportunities with existing clients of an entity, according to the principles of the present disclosure. At 702, the system 700 (another exemplary embodiment of business acquisition unit 300 of FIG. 3) receives, at an application programming interface (API), at least one data object associated with recent activity of a client. For example, a borrower's recent activity data may include any of the following: loan type, time since the last loan, amount of money that can be saved compared to current loan, FICO score, bankruptcies, foreclosures, late payments or any other available data on the potential borrower.

At 704, the system 700 queries the data store for at least one data object associated with previous activity of the client. For example, the previous activity of the client may include any of the following: information associated with a previous or current loan, loan type, time since the last loan, amount of money that can be saved compared to current loan, FICO score, bankruptcies, foreclosures, late payments or any other available data on the potential borrower.

At 706, the system 700 determines, based on the at least one data object associated with the recent activity of the client and the at least one data object associated with the previous activity of the client, that the client meets minimum standards for a service provided by an entity. To help illustrate, in one scenario, based on loan information associated with a previous loan and the client's current FICO score, it may be determined if the client meets minimum standards or requirements (e.g., debt-to-income ratio, FICO score, work history, etc.) to qualify for a loan or mortgage.

At 708, the system 700 determines an availability of an agent associated with the entity to provide the service to the client. For example, the system 700 may determine if a loan officers is available to receive the text, available to enage the client, etc.

At 710, the system 700 determines which client information is pertinent to providing the service to the client. The client information is associated with the at least one data object associated with the recent activity of the client and the at least one data object associated with the previous activity of the client. For example, the system 700 determines which client information (e.g., borrower's contact information, borrowing limit, employment history, etc.) is pertinent to providing the service (e.g., a mortgage) to the client.

At 712, the system 700 identifies a computing device associated with the agent associated with the entity. For example, the system 700 identifies a computing device (e.g., a computer, smart phone, smart wearable, etc.) associated with a loan officer of a lending company.

At 714, the system 700 generates, at a message generation API, at least one messaging data object including one or more text strings indicating the client information. For example, the message sent to a loan officer can be by any communication means such as, but not limited to, SMS text message, email, instant message, and the like. The message contains at least two links, one link to initiate communication with the potential borrower based on contact information from the data object or the internal server.

At 716, the system 700 provides the messaging data object to the computing device of the agent associated with the entity. For example, the system 700 provides the messaging data object to a computing device (e.g., a computer, smart phone, smart wearable, etc.) associated with a loan officer of a lending company.

In some embodiments, a method may include receiving, from a sales lead server, a data object having loan data related to a potential borrower. The method may further include comparing, by a processor, the potential borrower data stored in the data object with the corresponding potential borrower data in an internal server associated with the potential borrower. The method may include generating a potential borrower data interface where the potential borrower data interface includes potential borrower data most associated with leading to a new loan based on loan history data from the internal server. The method may include determining, based on potential borrower data in the internal server, a loan officer associated with the potential borrower. The method may further include generating, by the processor, a message to the loan officer having a first link associated with the potential borrower data interface and a second link associated with a contact information of the potential borrower from the internal server. The method may further include generating a notification to the loan officer based on tracking the first link and determining it has not been used. The method may further include determining a level of success in creating a new loan for the potential borrower and storing the loan data with the data from the potential borrower data interface in the internal server.

In some embodiments, a method may include receiving at least one data object associated with a potential borrower. The method may include determining, based on the at least one data object, whether to contact the potential borrower. The method may include, in response to a determination to contact the potential borrower, generating, using at least the at least one data object, one or more text strings indicating information associated with the potential borrower. The method may include generating, using a message generation application programming interface, at least one messaging data object including the one or more text strings indicating the information associated with the potential borrower. The method may include identifying a computing device associated with an intended recipient of the messaging data object, the recipe it being associated with the potential borrower. The method may include selectively communicating the messaging data object to the computing device associated with the recipient. The method may include after a predetermined period and in response to information indicating that the recipient has not contacted the potential borrower, subsequently communicating, at least, the messaging data object to the computing device of the recipient.

In some embodiments described herein include an application programming interface (API) that is configured to receive data associated with recent activity of a client and a business acquisition unit that is configured to update a data store with the data associated with the recent activity of the client, query the data store for data associated with previous activity of the client, and determine, based on the data associated with the recent activity of the client and the data associated with the previous activity of the client, that the client meets minimum standards for a service provided by an entity. The business acquisition unit is also configured to determine an availability of an agent associated with the entity of the entity to provide the service to the client, determine which client information is pertinent to providing the service to the client, and identify a computing device associated with the agent associated with the entity. Additionally, embodiments described herein include a message generation API that is configured to generate a messaging data object indicating the client information and provide the messaging data object to the computing device of the agent associated with the entity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated.

While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A system comprising:
one or more processors, and one or more memory devices storing programming logic that, when executed by the one or more processors, cause the one or more processors to:
receive, at an application programming interface (API), at least one data object associated with recent activity of a client;
update a data store with the at least one data object associated with the recent activity of the client;
query the data store for at least one data object associated with previous activity of the client;
determine, based on the at least one data object associated with the recent activity of the client and the at least one data object associated with the previous activity of the client, that the client meets minimum standards for a service provided by an entity;
determine an availability of an agent associated with the entity of the entity to provide the service to the client;
determine which client information is pertinent to providing the service to the client, the client information being associated with the at least one data object associated with the recent activity of the client and the at least one data object associated with the previous activity of the client;
identify a computing device associated with the agent associated with the entity;
generate, at a message generation API, at least one messaging data object including one or more text strings indicating the client information; and
provide the messaging data object to the computing device of the agent associated with the entity.

2. The system of claim 1, wherein the one or more memory devices further store programming logic that cause the one or more processors to:
determine which client information is pertinent to providing the service to the client using a neural network.

3. The system of claim 1, wherein the one or more memory devices further store programming logic that cause the one or more processors to:
after a predetermined period and in response to information indicating that the agent associated with the entity has not contacted the client, subsequently communicating, at least, the messaging data object to the computing device of the agent associated with the entity.

4. The system of claim 1, wherein the one or more memory devices further store programming logic that cause the one or more processors to:
predict when the client will need the service.

5. The system of claim 1, wherein the at least one messaging data object includes a click to call link with client information.

6. The system of claim 1, wherein the one or more memory devices further store programming logic that cause the one or more processors to:
generate automatic reminders to track if the agent associated with the entity has contacted the client.

7. The system of claim 1, wherein the one or more memory devices further store programming logic that cause the one or more processors to:
generate a message to the agent associated with the entity having a first link associated with a client data interface and a second link associated with contact information of the client from the data store.

8. A system comprising:
one or more processors, and
one or more memory devices storing programming logic that, when executed by the one or more processors, cause the one or more processors to:
update a data store with at least one data object associated with recent activity of a client;
query the data store for at least one data object associated with previous activity of the client;
determine, based on the at least one data object associated with the recent activity of the client and the at least one data object associated with the previous activity of the client, that the client meets minimum standards for a service provided by an entity;
determine an availability of an agent associated with the entity of the entity to provide the service to the client;
determine which client information is pertinent to providing the service to the client, the client information being associated with the at least one data object associated with the recent activity of the client and the at least one data object associated with the previous activity of the client; and
identify a computing device associated with the agent associated with the entity.

9. The system of claim 8, wherein the one or more memory devices further store programming logic that cause the one or more processors to:
determine which client information is pertinent to providing the service to the client using a neural network.

10. The system of claim 8, wherein the one or more memory devices further store programming logic that cause the one or more processors to:
receive, at an application programming interface (API), the at least one data object associated with the recent activity of the client.

11. The system of claim 8, wherein the one or more memory devices further store programming logic that cause the one or more processors to:
generate, at a message generation API, at least one messaging data object including one or more text strings indicating the client information; and
provide the messaging data object to the computing device of the agent associated with the entity.

12. The system of claim 11, wherein the one or more memory devices further store programming logic that cause the one or more processors to:
after a predetermined period and in response to information indicating that the agent associated with the entity has not contacted the client, subsequently communicating, at least, the messaging data object to the computing device of the agent associated with the entity.

13. The system of claim 11, wherein the at least one messaging data object includes a click to call link with client information.

14. The system of claim 11, wherein the one or more memory devices further store programming logic that cause the one or more processors to:
generate, at the message generation API, a message to the agent associated with the entity having a first link associated with a client data interface and a second link associated with contact information of the client from the data store.

15. The system of claim 8, wherein the one or more memory devices further store programming logic that cause the one or more processors to:
predict when the client will need the service.

16. The system of claim 8, wherein the one or more memory devices further store programming logic that cause the one or more processors to:
generate automatic reminders to track if the agent associated with the entity has contacted the client.

17. A method, comprising:
receiving at least one data object associated with recent activity of a client;
updating a data store with the at least one data object associated with the recent activity of the client;
querying the data store for at least one data object associated with previous activity of the client;
determining, based on the at least one data object associated with the recent activity of the client and the at least one data object associated with the previous activity of the client, that the client meets minimum standards for a service provided by an entity;
determining an availability of an agent associated with the entity to provide the service to the client;
determining which client information is pertinent to providing the service to the client, the client information being associated with the at least one data object associated with the recent activity of the client and the at least one data object associated with the previous activity of the client;
identifying a computing device associated with the agent associated with the entity;
generating at least one messaging data object including one or more text strings indicating the client information; and
providing the messaging data object to the computing device of the agent associated with the entity.

18. The method of claim 17, further comprising determining which client information is pertinent to providing the service to the client using a neural network.

19. The method of claim 17, further comprising, after a predetermined period and in response to information indicating that the agent associated with the entity has not contacted the client, subsequently communicating, at least, the messaging data object to the computing device of the agent associated with the entity.

20. The method of claim 17, further comprising predicting when the client will need the service.
